(19) United States
(12) Patent Application Publication
(10) Pub. No.: US 2023/0117124 A1
(43) Pub. Date: Apr. 20, 2023

(54) Composition for Sterilization of Tree Cutting Devices and a Method of Use Thereof

(71) Applicant: Christopher Francais Ruvalcaba, Portland, OR (US)

(72) Inventor: Christopher Francais Ruvalcaba, Portland, OR (US)

(21) Appl. No.: 18/068,085

(22) Filed: Dec. 19, 2022

Related U.S. Application Data
(62) Division of application No. 17/339,556, filed on Jun. 4, 2021.
(60) Provisional application No. 63/142,104, filed on Jan. 27, 2021.

(51) Int. Cl. A01N 65/28; A01N 65/22; A01N 65/36; A01N 65/24

(52) U.S. Cl. CPC A01N 65/28; A01N 65/22; A01N 65/36; A01N 65/24

(57) ABSTRACT

A composition for a sterilizing solution and a method of use thereof intent to provide the user a sterile lubricant for a chainsaw/bandsaw machine, such that they inhibit the spread of tree infections from one tree to another during the process of cutting multiple trees. Preferably, the sterilizing solution includes essential oils that contain terpenes, carvacrol, eugenol, thymol, and other anti-fungal, anti-bacterial, and anti-viral elements. Further, the method of application provides the user the ability to continuously cut one tree after another without the potential danger of spreading an infection from one tree to another tree. Additionally, the method enables users to apply the sterilizing solution over cutting blades as well as over cut tree stumps, thereby sterilizing the surfaces, repelling bugs and preventing infections that are associated with the tree cutting process. Furthermore, the sterilizing solution is a plant-based biodegradable sterilizer that does not harm the environment when used.

The current application claims a priority to the U.S. provisional patent application Ser. No. 63/142,104 filed on Jan. 27, 2021.

### FIELD OF THE INVENTION

The present invention relates generally to lubricants for tree cutting devices. More specifically, the present invention provides a disinfectant solution that is used in unison with the lubrication of chainsaws/bandsaws.

### BACKGROUND OF THE INVENTION

When it comes to cutting down trees with a chainsaw/bandsaw, there are numerous diseases, bacteria, fungal infections, and pathogen infections that are unseen to the blind eye. Cutting one tree after the another with a chainsaw creates an issue of potentially spreading the infection while in the process of cutting one tree after another. Spreading tree infections from one tree to another is very common. It is recommended that the user of a chainsaw is informed of the potential effects of cutting one tree after another without sterilizing the chainsaw.

An objective of the present invention is to provide users with a disinfectant formula for lubricants of a chainsaw/bandsaw that inhibit the spread of tree infections or of the likes from one tree to another during the process of cutting multiple trees. In addition, the disinfectant formula of the present invention can be added into a wide range of different lubricants of chainsaws/bandsaws. In addition, the present invention discusses a method that provides the user the ability to continuously cut one tree after another without the potential danger of spreading an infection of one tree to another tree. Furthermore, the present invention is a plant-based biodegradable sterilizer that does not harm the environment when used.

### BRIEF DESCRIPTION OF THE DRAWINGS

FIG. 1 is a block diagram illustrating the ingredients of the present invention.

FIG. 2 is a table illustrating the proportions and benefits of the ingredients of the present invention.

FIG. 3 is a block diagram illustrating the proportions of the present invention.

FIG. 4 is a flow diagram illustrating a method of mixing the present invention with a lubricant and continuously sterilizing the bars of a wood cutting machine.

FIG. 5 is a flow diagram illustrating a method of applying the present invention over a cutting blade as well as over a stump of a cut surface.

### DETAIL DESCRIPTIONS OF THE INVENTION

All illustrations of the drawings are for the purpose of describing selected versions of the present invention and are not intended to limit the scope of the present invention.

The present invention is a composition for a sterilizing solution and a method of use thereof. An objective of the present invention is to provide the user a disinfectant formula for lubricants of a chainsaw/bandsaw that inhibit the spread of tree infections or of the likes from one tree to another during the process of cutting multiple trees. In addition, the disinfectant formula of the present invention can be added into a wide range of different lubricants of chainsaws/bandsaws. In addition, the present invention discusses a method that provides the user the ability to continuously cut one tree after another without the potential danger of spreading an infection of one tree to another tree. Furthermore, the present invention is a plant-based biodegradable sterilizer that does not harm the environment when used.

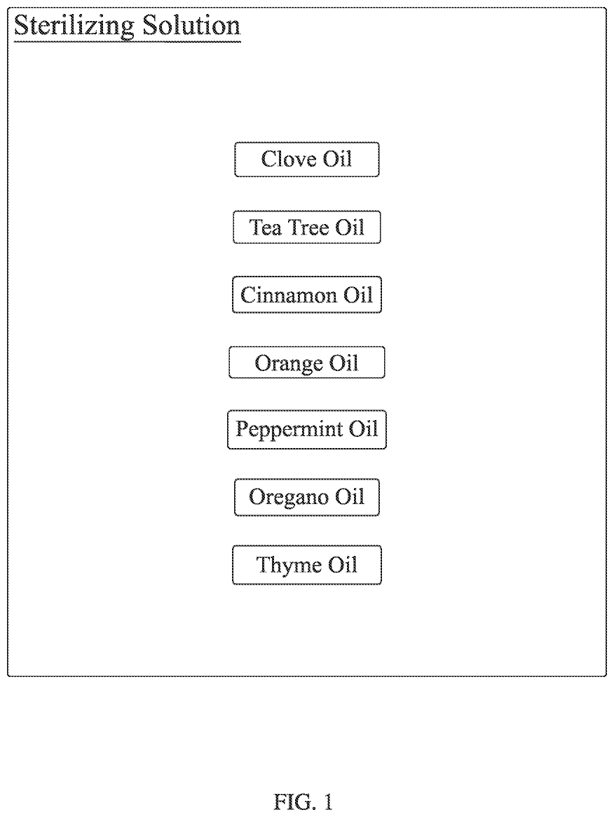

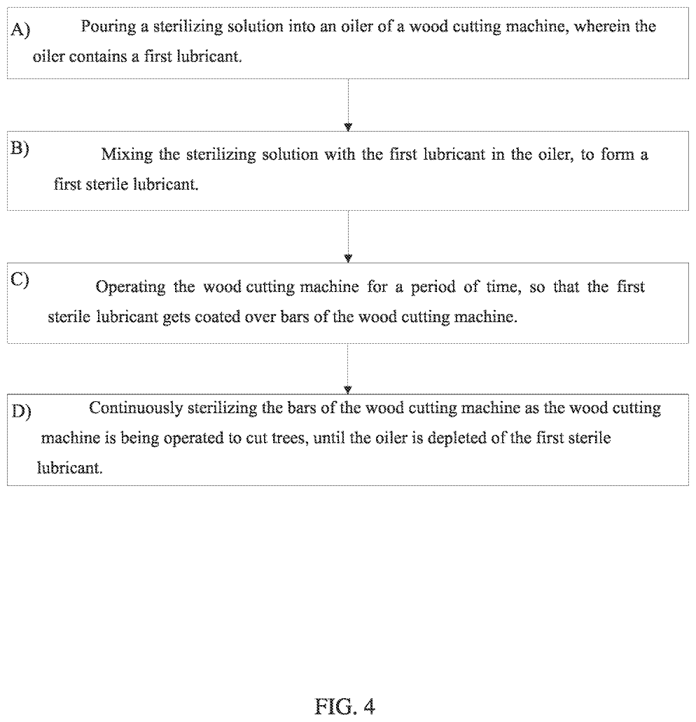

The following description is in reference to FIG. 1 through FIG. 5. As seen in FIG. 1, the formula of the present invention comprises a variety of plant-based oils. Preferably, the present invention primarily comprises essential oils that contain terpenes, carvacrol, eugenol, thymol, and other anti-fungal, anti-bacterial, and anti-viral elements. More specifically, the present invention comprises a quantity of clove oil, a quantity of tea tree oil, a quantity of cinnamon oil, a quantity of orange oil, a quantity of peppermint oil, a quantity of oregano oil, and a quantity of thyme oil, wherein the quantity of clove oil, the quantity of tea tree oil, the quantity of cinnamon oil, the quantity of orange oil, the quantity of peppermint oil, the quantity of oregano oil, and the quantity of thyme oil are homogeneously mixed into a sterilizing solution. However, it should be noted that the formula of the present invention may change and include more or less of the ingredients disclosed as well as other ingredients such as lemongrass, citronella, thyme, etc., as long as the objectives of the present invention are fulfilled. In addition, the present invention may also be used as a bug repellent which deter insects that may potentially carry an infection, fungus, or of the likes.

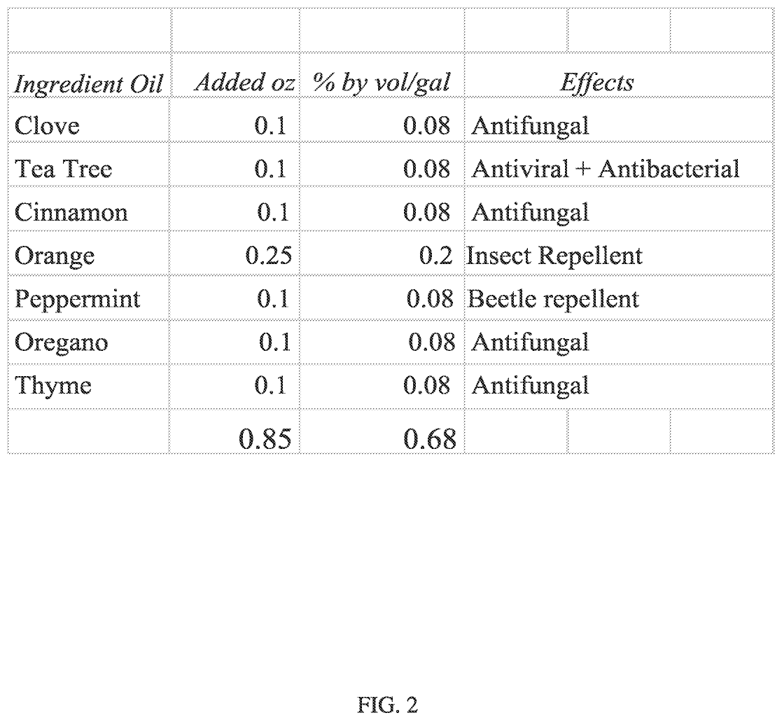

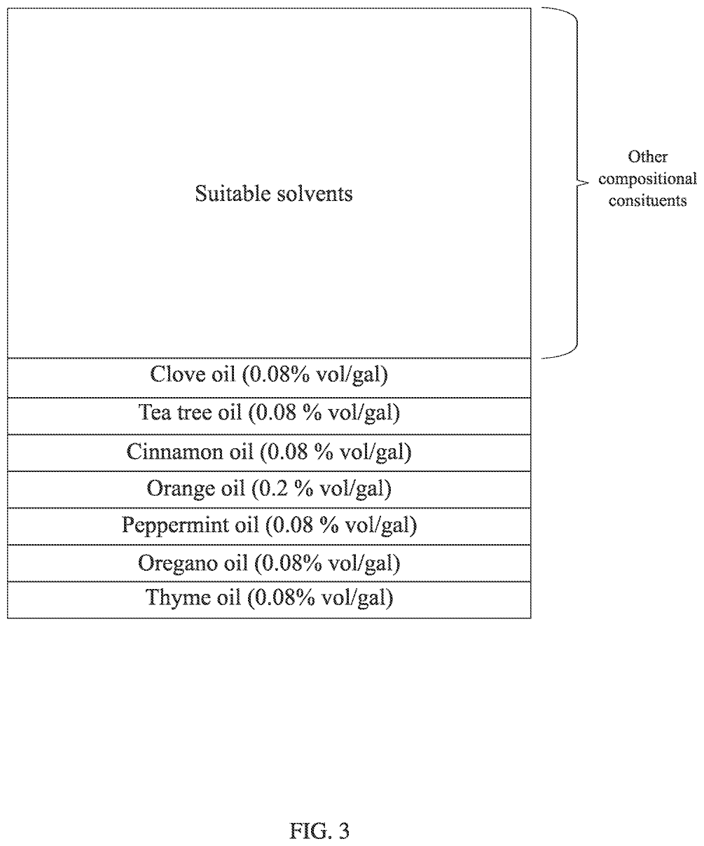

In reference to FIG. 2 and FIG. 3, the composition of each ingredient of the present invention is given in percentage volume, per gallon of liquid, according to the preferred embodiment. Accordingly, the quantity of clove oil is approximately 0.08 percentage by volume (vol. %) of the sterilizing solution, the quantity of tea tree oil is approximately 0.08 vol. % of the sterilizing solution, the quantity cinnamon oil is approximately 0.08 vol. % of the sterilizing solution, the quantity of orange oil is approximately 0.2 vol. % of the sterilizing solution, the quantity of peppermint oil is approximately 0.08 vol. % of the sterilizing solution, the quantity of oregano oil is approximately 0.08 vol. % of the sterilizing solution, and the quantity of thyme oil is approximately 0.08 vol. % of the sterilizing solution. In other words, in the preferred embodiment, approximately 0.08 vol % per gallon of each ingredient is mixed with other oil, water (if making in smaller quantities), or other suitable solvents, so as to prepare a sterilizing solution. i.e., the sterilizing solution may be an oil in water emulsion or an oil in oil emulsion. However, it should be noted that, the sterilizing solution may comprise any variety of suitable solvents, and/or one or more ingredients that are known to one of ordinary skill in the art may be mixed in different concentrations, as long as the intents of the present invention are not altered. Further, each ingredient has specific antiviral, antifungal, and bug repellent properties, which makes the sterilizing solution and excellent source for deterring insects that carry infections as well as other deceases that are prone to transfer during tree cutting process. More specifically, as seen in FIG. 2, clove oil, cinnamon oil, oregano oil and thyme oil have antifungal properties; tea tree oil has antiviral and antifungal properties; orange oil is an excellent bug repellant; and peppermint oil is specifically good at repelling beetles. Thus, the present invention provides sufficient protection from bugs and many infections that are usually associated with the tree cutting process.

In the preferred embodiment, the present invention is a disinfectant formula that may be mixed and added to a lubricant of the user's choice. Further, it is preferred that the present invention be added into the chainsaw/bandsaw oiler, so that the lubricant in the oiler can be the carrier of the present invention and may be used within a chainsaw/bandsaw. To accomplish this, a preferred method of application of the sterilizing solution follows. According to the preferred embodiment, the method comprises, pouring a sterilizing solution into an oiler of a wood cutting machine, wherein the oiler contains a first lubricant (Step A). In other words, the oiler is a container tank that already contains the first lubricant, and the sterilizing solution is poured into the oiler. Following that, the sterilizing solution is mixed with the first lubricant in the oiler, to form a first sterile lubricant (Step B). Alternately, the user may premix the sterilizing solution and the first lubricant, and simply pour the mixture (first sterile lubricant) into the chainsaw/bandsaw oiler until the tank is full. Subsequently, the wood cutting machine is operated for a period of time, so that the first sterile lubricant gets coated over bars of the wood cutting machine (Step C). In other words, once the oiler of the chainsaw/bandsaw machine is filled with the mixture of disinfectant solution and lubricant, the user will need to operate and run the chainsaw/bandsaw machine for a few seconds in order to allow the oiler to properly coat the bars and chains of the chainsaw/bandsaw. Subsequently, the bars of the wood cutting machine get continuously sterilized as the wood cutting machine is being operated to cut trees, until the oiler is depleted of the first sterile lubricant (Step D). In other words, once the user has covered the bars of the chainsaw/bandsaw, the user is ready to operate the wood cutting machine and cut down multiple trees. In the preferred embodiment, the wood cutting machine is a chainsaw/bandsaw. However, it should be noted that, the wood cutting machine may comprise any size, brand, technology, components and arrangement of components that are known to one of ordinary skill in the art, as long as the objectives of the present invention are fulfilled. Thus, by following the method of adding the sterilizing solution and lubricant to the oiler and bar of the chainsaw/bandsaw, the present invention will allow the user to cut down one tree after another without the potential danger of spreading the infection of one tree to the another. This is because the first sterile lubricant acts as a disinfectant and insect repellent.

In the preferred embodiment, the direction of the oil flow follows the chain rotation while the chainsaw/bandsaw is in use. More specifically, the cyclization of the chain on the bars of the chainsaw/bandsaw ensures a continuous application of disinfectant while chainsaw/bandsaw is in use. As the user is cutting down trees, the oiler of the user's chainsaw/bandsaw will disperse the first sterile lubricant onto the bar and chain of the chainsaw/bandsaw. While in the process of cutting a tree, sterilization of the chainsaw occurs continuously which will continuously disinfect from one tree cut to the next tree cut until the oiler of the chainsaw/bandsaw.

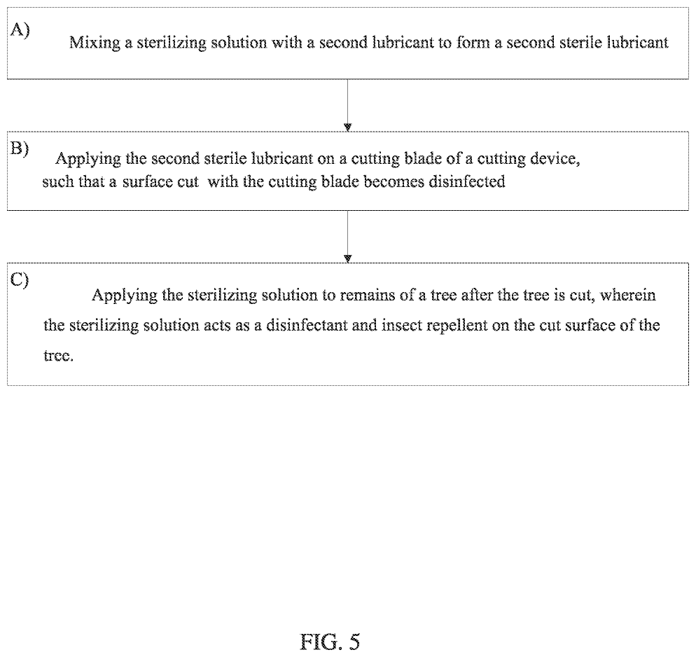

In reference to FIG. 5, the present invention is a disinfectant formula that may be mixed and added to the lubricant of the user's choice. To that end, the present invention may be pre-mixed into any lubricant that the user applies to their cutting device. Accordingly, a method of application of the present invention comprises, mixing a sterilizing solution with a second lubricant to form a second sterile lubricant (Step A). Subsequently, the second sterile lubricant may be applied on a cutting blade of a cutting device, such that a surface cut with the cutting blade becomes disinfected (Step B). In other words, by applying the second sterile lubricant over the blades of a cutting device (either an automatic or manual cutting device), the blades get sterilized, thereby helping with disinfecting one tree cut to the next tree cut and preventing spread of any infections.

According to the preferred embodiment, the present invention comprises elements that have specific properties in arboricultural practices. The present invention comprises oils that may act as insect repellents. The present invention primarily comprises essential oils that contain terpenes, carvacrol, eugenol, thymol, and other anti-fungal, anti-bacterial, and anti-viral elements. Accordingly, another method of application of the present invention comprises applying the sterilizing solution to remains of a tree after the tree is cut, wherein the sterilizing solution acts as a disinfectant and insect repellent on the cut surface of the tree. More specifically, after the process of cutting trees, the present invention may be applied to the remains of a tree, such as a tree stump. The fresh cuts and wounds of a tree attracts insects such as beetles. The attracted insects may potentially carry infections and contaminate the tree stump. Accordingly, by applying the sterilizing solution, the present invention will simply coat the fresh cut or wound of the tree which will deter insects away from contamination of the tree. Thus, the present invention will protect and prevent any potential infections to a healthy tree as it disinfects the chainsaw/bandsaw and repels insect away from the fresh cut/wound.

Although the invention has been explained in relation to its preferred embodiment, it is to be understood that many other possible modifications and variations can be made without departing from the spirit and scope of the invention as hereinafter claimed.

What is claimed is:

1. A method of application of a sterilizing solution comprising:
pouring a sterilizing solution into an oiler of a wood cutting machine, wherein the oiler contains a first lubricant;
mixing the sterilizing solution with the first lubricant in the oiler, to form a first sterile lubricant;
operating the wood cutting machine for a period of time, so that the first sterile lubricant gets coated over bars of the wood cutting machine;
continuously sterilizing the bars of the wood cutting machine as the wood cutting machine is being operated to cut trees, until the oiler is depleted of the first sterile lubricant.

2. The method of claim 1, wherein the first sterile lubricant acts as a disinfectant and insect repellent.

3. A method of application of a sterilizing solution comprising:
mixing a sterilizing solution with a second lubricant to form a second sterile lubricant;
applying the second sterile lubricant on a cutting blade of a cutting device, such that a surface cut with the cutting blade becomes disinfected.

4. The method of claim 3, comprising:
applying the sterilizing solution to remains of a tree after the tree is cut, wherein the sterilizing solution acts as a disinfectant and insect repellent on the cut surface of the tree.
